(19) United States
(12) Patent Application Publication
(10) Pub. No.: US 2026/0217934 A1
(43) Pub. Date: Jul. 30, 2026

(54) METHOD FOR COATING OF POLYSTYRENE PARTICLES

(71) Applicant: IOI Oleo GmbH, Hamburg (DE)

(72) Inventors: Sebastian REYER, Hamburg (DE); Michael STEHR, Hamburg (DE); Andreas WINTZER, Hamburg (DE)

(21) Appl. No.: 19/141,907

(22) PCT Filed: Feb. 28, 2023
(86) PCT No.: PCT/EP2023/054949

§ 371 Date: Jun. 20, 2025

(30) Foreign Application Priority Data
Dec. 20, 2022 (WO) PCT/EP2022/086935

(51) Int. Cl. C08J 9/224; C08J 9/00; C08J 9/14; C08K 5/103; C09D 7/63

(52) U.S. Cl. CPC C08J 9/224; C08J 9/0023; C08J 9/141; C08K 5/103; C09D 7/63; C08J 2203/14; C08J 2325/06

(57) ABSTRACT

The present invention refers to a method for providing polystyrene beads, especially expandable polystyrene beads, with a coating, especially with an antistatic and/or antilumping coating, and to the polystyrene beads thus obtainable as well as to a respective coating agent to be used in such method.

### CROSS-REFERENCES TO RELATED APPLICATIONS

This application is a National Stage filing of International Application PCT/EP 2023/054949, filed Feb. 28, 2023, entitled “METHOD FOR COATING OF POLYSTYRENE PARTICLES” claiming priority to PCT/EP 2022/086935 filed Dec. 20, 2022. The subject application claims priority to PCT/EP 2022/086935 and PCT/EP 2023/054949 and incorporates all by reference herein, in their entirety.

### BACKGROUND OF THE INVENTION

The present invention relates to the technical field of foamable and/or expandable polymers and polymeric foams, especially foamable and/or expandable polystyrene-based or polystyrene-containing materials especially in particulate form (e. g. beads, spherules etc.).

Especially, the present invention relates to a method for providing polystyrene beads, especially expandable polystyrene beads, with a coating, especially with an antistatic and/or antilumping coating, as well as to the inventive coated polystyrene beads thus obtainable or thus produced (i.e. polystyrene beads, especially expandable polystyrene beads, provided with a coating, especially with an antistatic and/or antilumping coating).

Furthermore, the present invention relates to a coating agent, especially for providing polystyrene beads, especially expandable polystyrene beads, with a coating, especially with an antistatic and/or antilumping coating, as well as to the respective uses or usages of such coating agent.

Expanded polystyrene (EPS) or extruded polystyrene (XPS), respectively—commonly also known as Styropor® or Styrofoam™, respectively—is a polymeric foam consisting of polystyrene and a blowing agent, like pentane. It is mainly used as insulating material in construction but also for all kinds of packaging.

Polystyrene foams are 95 to 98% air. Thus, they are good thermal insulators and therefore often used as building insulation materials, such as in insulating concrete forms and structural insulated panel building systems.

Expanded polystyrene is a rigid and tough closed-cell foam with a typical density of 5 to 32 kg/m³. It is usually white and produced from pre-expanded polystyrene beads. Grey polystyrene foam is also available and typically incorporates graphite and has superior insulating properties.

The overall production process for expanded polystyrene usually starts with the production of small polystyrene beads. Styrene monomers (and optionally additives) are suspended in water, wherein they undergo free-radical addition polymerization. The polystyrene beads formed by this mechanism may have an average diameter of about 200 μm. The beads are then infused with a so-called blowing agent, a material which boils below the softening point of the polymer and which will cause the beads to expand when heated. Typically, pentane is used as the blowing agent. To infuse the blowing agent different techniques are known, for example pressure impregnation of thermoplastic polymer particles with blowing agents in a vessel, by suspension polymerization in the presence of blowing agents, or by melt impregnation in an extruder or static mixer followed by pressure underwater pelletizing.

For further processing, the blowing agent-containing polystyrene beads (i.e. the expandable polystyrene beads) are then first pre-expanded or pre-foamed in water vapor, wherein the polystyrene beads may expand up to 20 to 50 times related to their original size. Subsequently, the pre-expanded polystyrene beads are molded in a set form and size. This product may be a so-called block- or form-molded material, depending on the type of molding equipment used. The molding equipment is also called mold.

Once the expanded polystyrene has been manufactured, it is cut with highly heated 5 lengths of wire which are made of a product called nichrome—a non-metallic alloy of nickel and chrome. This metal resists oxidation at high temperatures and conducts electricity surprisingly well. The wire is heated to extreme temperatures and “cuts” the expanded polystyrene by vaporizing the foam as it passes through it. This process gives the resulting product a silky-smooth surface and allows manufacturers to cut and shape it into any design imaginable.

If untreated or naked expandable polystyrene beads (i.e. blowing agent-containing polystyrene beads) are pre-expanded, the pre-expanded particles tend to clump together and form lumps which render the particles unsuitable for molding. Especially, 15 these lumps cannot be properly conveyed in processing plants and are unsuitable for charging into the molds due to improper fill-out of the mold. Even if reasonable fill-out is achieved, variations in density with the molded article can result and voids also occur, leading to a defective or low-quality product.

To enable unproblematic processing and molding, especially conveying, and to reduce electrostatic charging of the pre-expanded polystyrene, a coating is necessary. Various methods and coatings have been proposed in the prior art, for example the coating with an antistatic agent. However, abrasion or wash-off of the antistatic agent from the surface of the particles often results in unsatisfactory antistatic properties. 25 Furthermore, coating with the antistatic agent can lead to sticking of the particles and poor trickling behavior and thus also to improper fill-out of the mold.

Many commonly used coatings comprise mixtures of several components. Common are for example compositions based on glycerin derivatives, like different glycerol monostearate types, glycerol tristearate types as well as other additives (for example Zn-stearate, Ca-stearate and Mg-stearate). Other possible additives are citrates, paraffin waxes or coloring agents. These types of components, especially the glycerol compounds and stearate compounds, make it necessary to provide and/or apply the coating via a 5 dry coating process to the surface of the expandable polystyrene bead. The functionality of these components is not completely understood, however, it is commonly known that substances which support the pre-expansion step tend to impede the molding step and vice versa. Additionally, the use of metal soaps also creates environmental concerns (e. g. waste water) and furthermore limits the final applications due to regulatory restrictions.

The development of an optimized coating composition performing well in all steps of expanded polystyrene processing is difficult, time consuming and often ends up in very complex recipes, which create an obstacle for a smooth and reproducible production 15 and handling. Furthermore, the thermal sensitivity of glycerol tristearates containing compositions may alter the coating properties unnoticed, resulting in an impaired processing performance and changing coating quality.

In the prior art a variety of different coatings have been developed:

U.S. Pat. No. 3,520,833 A teaches the addition of lecithin during the impregnation of the particles with the blowing agent. Unfortunately, the lecithin imparts an undesirable odor to the molded articles.

U.S. Pat. No. 3,462,293 A teaches to coat the particles with polymeric materials by a fluid bed process. This process involves an additional expense of fluidizing the particles and coating with the polymer latexes and thus represents a more complex and costly overall process.

U.S. Pat. No. 3,444,104 A teaches the addition of calcium silico aluminate. This additive does not allow pre-expanding or less than about 1 pound per cubic foot density to be prepared.

EP 0 470 455 A1 describes peri-form antistatic expandable styrene polymers with a coating of a quaternary ammonium salt and finely divided silica, which are characterized by good trickling behavior.

DE 195 41 725 C1 describes expandable polystyrene beads with reduced water absorption capacity which are provided with a coating containing, in addition to glycerol tristearate, zinc stearate, and glycerol monostearate, from 5 to 50% by weight, based on the weight of the coating, of a hydrophobic silicate.

DE 195 30 548 A1 describes expandable polystyrene beads with reduced water absorption capacity, which are provided with a coating which, in addition to 10 to 90% by weight, based on the weight of the coating, of coconut fat or paraffin oil, advantageously also contain an antiadhesive agent based on a hydrophobic silicate.

GB 1 581 237 A describes, among other things, the use of castor wax (hydrogenated castor oil) as a coating agent for expandable polystyrene to improve the demoldability and quality of the foam moldings after sintering of the pre-expanded polystyrene beads.

Consequently, the prior art has not lacked attempts to find efficient methods and coatings, however, these methods and coatings still suffer from various disadvantages such as rapid loss of blowing agent, poor flow of the treated beads, dust problems which cause plugging of the steam ports and serious reduction in fusion of the particles during molding, the need for complex coating agents with various components, which can especially lead to application errors such as dosage errors, non-homogeneous coatings, lumping still occurring to a certain extent, coatings which are not oxidation stable and do not sufficiently adhere to the polystyrene beads.

### BRIEF SUMMARY OF THE INVENTION

The problem underlying the present invention is thus providing an efficient method for providing polystyrene beads, especially expandable polystyrene beads, with a coating, especially with an antistatic and/or antilumping coating, wherein the aforementioned disadvantages and/or drawbacks of the prior art should be at least partially avoided or at least essentially overcome.

Especially, a problem underlying the present invention is thus providing an efficient method for providing polystyrene beads, especially expandable polystyrene beads, with a coating, especially with an antistatic and/or antilumping coating, wherein the coating agent has improved processability and can optionally be provided as a one-component coating agent.

Furthermore, a problem underlying the present invention is thus providing an efficient method for providing polystyrene beads, especially expandable polystyrene beads, with a coating, especially with an antistatic and/or antilumping coating, wherein the coating agent is stable to oxidation and adheres well to the polystyrene beads.

Moreover, a problem underlying the present invention is thus providing an efficient method for providing polystyrene beads, especially expandable polystyrene beads, with a coating, especially with an antistatic and/or antilumping coating, wherein expanded polystyrene produced from the coated expandable polystyrene beads after pre-expansion and molding have good mechanical properties.

Additionally, a problem underlying the present invention is thus also providing an efficient method for providing polystyrene beads, especially expandable polystyrene beads, with a coating, especially with an antistatic and/or antilumping coating, wherein at least essentially no lumping occurs after pre-expansion.

In a completely surprising way, applicant has now found out that using a coating agent which comprises or at least essentially consists of at least one fatty acid ester of a polyglycerol will improve the coating stability while reducing the formulation complexity since a one-component coating agent can be used, improve handling and supply chain management and make different coating processes such as dry coating, wet coating and molten coating equally possible. Especially better or at least equivalent coating results are achieved while using slightly lower coating agent concentrations than in the prior art. Furthermore, when using the coated expandable polystyrene beads as a starting material, processability is well-balanced over the whole process of producing a respective polystyrene foam-based article.

Thus, in order to solve the problem described hereinabove, the present invention therefore proposes—according to a first aspect of the present invention—a method for providing polystyrene beads, especially expandable polystyrene beads, with a coating, especially with an antistatic and/or antilumping coating, as described herein; further, especially special and/or advantageous embodiments of the inventive method are similarly provided.

Furthermore, the present invention relates—according to a second aspect of the present invention—to polystyrene beads, especially expandable polystyrene beads, provided with a coating, especially with an antistatic and/or antilumping coating.

Likewise, the present invention—according to a third aspect of the present invention—relates to a coating agent, especially for providing polystyrene beads, especially expandable polystyrene beads, with a coating, especially with an antistatic and/or antilumping coating, further, especially special and/or advantageous embodiments of this aspect of the invention are also described.

Finally, the present invention—according to a fourth aspect of the present invention—also relates to the use of a coating agent or at least one fatty acid ester of a polyglycerol as a coating agent for polystyrene beads, especially expandable polystyrene beads, particularly for providing polystyrene beads, especially expandable polystyrene beads, with a coating, especially with an antistatic and/or antilumping coating; and, especially special and/or advantageous embodiments of this aspect of the invention are provided.

It goes without saying that following features, embodiments, advantages and the like, which are subsequently listed below only with regard to one aspect of the invention for the purpose of avoiding repetition, naturally also apply accordingly to the other aspects of the invention, without this requiring a separate mention.

Furthermore, it goes without saying that individual aspects and embodiments of the present invention are also considered disclosed in any combination with other aspects and embodiments of the present invention and, especially, any combination of features and embodiments, as it results from back references of all patent claims, is also considered extensively disclosed with regard to all resulting combinations possibilities.

With respect to all relative or percentage weight-based data provided below, especially relative quantity or weight data, it should further be noted that within the scope of the present invention these are to be selected by the person skilled in the art such that they always add up to 100% or 100 wt.-%, respectively, including all components or ingredients, especially as defined below; however, this is self-evident for the person skilled in the art.

In addition, the skilled person may, if necessary, deviate from the following range specifications without leaving the scope of the present invention.

In addition, it applies that all values or parameters or the like specified in the following can be determined or identified in principle with standardized or explicitly specified determination methods or otherwise with the determination or measurement methods that are otherwise familiar to a person skilled in the art.

### BRIEF DESCRIPTION OF THE DRAWINGS

FIG. 1a provides a 26-times magnified SEM-microscopic image of expandable polystyrene beads coated in a dry coating process with a partial stearic ester of a triglycerol;

FIG. 1b provides a 104-times magnified SEM-microscopic image of expandable polystyrene beads coated in a dry coating process with a partial stearic ester of a triglycerol;

FIG. 2a provides a 26-times magnified SEM-microscopic image of expandable polystyrene beads coated in a wet coating process with a partial stearic ester of a triglycerol;

FIG. 2b provides a 104-times magnified SEM-microscopic image of expandable polystyrene beads coated in a wet coating process with a partial stearic ester of a triglycerol;

FIG. 3a provides a 28-times magnified SEM-microscopic image of expandable polystyrene beads coated in a dry coating process with a partial stearic ester of a triglycerol;

FIG. 3b provides a 15-times magnified SEM-microscopic image of a fracture edge of expanded polystyrene foam generated by expansion of expandable polystyrene beads coated in a dry coating process with a partial stearic ester of a triglycerol;

FIG. 4a provides a 28-times magnified SEM-microscopic image of expandable polystyrene beads coated in a wet coating process with a partial pentaoleate ester of a tetraglycerol;

FIG. 4b provides a 15-times magnified SEM-microscopic image of a fracture edge of expanded polystyrene foam generated by expansion of expandable polystyrene beads coated in a wet coating process with a pentaoleate ester of a tetraglycerol.

### DETAILED DESCRIPTION OF THE INVENTION

Having stated this, the present invention will be described in more detail hereinafter:

The subject-matter of the present invention—according to a first aspect of the present invention—is thus a method for providing polystyrene beads, especially expandable polystyrene beads, with a coating, especially with an antistatic and/or antilumping coating,
wherein the method comprises the step of subjecting a plurality of polystyrene beads, 10 especially expandable polystyrene beads, to a coating process in the presence of a coating agent, wherein during the coating process the coating agent is deposited on the surface of the polystyrene beads, especially such that the surface of the polystyrene beads is coated and/or covered at least essentially completely and/or homogeneously with the coating agent,
wherein the coating agent comprises or at least essentially consists of at least one fatty acid ester of a polyglycerol, especially at least one partial fatty acid ester of a polyglycerol, preferably comprising free hydroxyl-groups (OH-groups), more preferably at least one partial polyglycerol ester of a saturated fatty acid which ester comprises free hydroxyl-groups.

In this respect, a partial fatty acid ester of a polyglycerol refers to non-full ester or a fatty acid ester of a polyglycerol comprising free hydroxyl-groups. Thus, not all hydroxyl-groups of the polyglycerol are esterified with a fatty acid.

By using a partial fatty acid ester of a polyglycerol and thus a coating agent with free hydroxyl-groups but still a high degree of esterification due to the polyglycerol, hydrophilicity and lipophilicity are well balanced and therefore a good adhesion, especially improved adhesion compared to prior art coatings, to the polystyrene beads is achieved.

Above all, also very surprisingly, by using the coating agent according to the present invention, especially the coating agent comprising or at least essentially consisting of at least one fatty acid ester of a polyglycerol, especially at least one partial fatty acid ester of a polyglycerol, preferably comprising free hydroxyl-groups (OH-groups), the coating stability is improved compared to the prior art.

Moreover, complexity of the coating agent is greatly reduced since one-component coating agents (i.e. coating agent only comprising or at least essentially only consisting of the at least one fatty acid ester of a polyglycerol, especially at least one partial fatty acid ester of a polyglycerol, preferably comprising free hydroxyl-groups (OH-groups)) can be used. Thus, no additional additives are needed to obtain a sufficiently working antistatic and/or antilumping coating. However, also the use of additives is possible, especially to tailor and/or adapt the coating accordingly.

Furthermore, especially due to the reduced formulation complexity, the handling and supply management is greatly improved to prior art coating agents and coating methods. Especially, the handling is significantly improved and also the error rate is greatly decreased, especially no errors with respect to amounts and ratios of different components can be made.

Surprisingly, the coating agent can be flexibly used in different coating processes; especially, the coating agent according to the present invention, especially the at least one fatty acid ester of a polyglycerol, especially at least one partial fatty acid ester of a polyglycerol, preferably comprising free hydroxyl-groups (OH-groups), can be applied to the surface of expandable polystyrene beads in a dry coating process, especially a powder coating process, a wet coating process and a molten coating process. Thus, when using the coating agent according to the present invention, the coating process is not limited to a fine powder process, as in the prior art.

Surprisingly, applicant has found that many disadvantages of the commonly applied coating-blend-technology can be overcome by the use of fatty acid esters of a polyglycerol as expandable polystyrene coating. Tests show that a single fatty acid ester of a polyglycerol can replace a classical multi component coating system. Compared to the standard coating product better or equivalent results are achieved by using a single fatty acid ester of a polyglycerol slightly below the usual concentration range. This reduces complexity, costs and CO₂ footprint simultaneously without losing final product properties.

Furthermore, the thermal stability of fatty acid esters of a polyglycerol compared to glycerol tristearates creates an additional advantage, as a performance loss over the storage time is avoided.

Additionally, the physicochemical properties of fatty acid esters of a polyglycerol make it possible to overcome the need to coat naked expandable polystyrene beads in a dry coating process, giving the possibility to coat beads with a molten additive in a e.g. fluidized bed or similar, which improves economics and coating quality, especially giving more homogenous coating layers.

Moreover, the coating agent according to the present invention, especially the at least one fatty acid ester of a polyglycerol, especially at least one partial fatty acid ester of a polyglycerol, preferably comprising free hydroxyl-groups (OH-groups), is oxidation stable, particularly due to the presence of only saturated fatty acids. This leads to further improvement in the handling and supply chain management.

Additionally, since the coating agent according to the present invention is especially a partial ester (i.e. comprising free hydroxyl-groups; in other words, not all hydroxyl groups are esterified with fatty acids), a good balance between hydrophilicity and lipophilicity results. This leads to improved adhesion to the polystyrene beads, especially since the carbon-chains can interact especially well with the surface of the polystyrene beads, especially with the non-polar groups of the polystyrene beads, while leaving free OH-groups providing antistatic properties.

Furthermore, using the coating agent according to the present invention, good or even improved mechanical properties both of the pre-expanded polystyrene beads and of the molded expanded polystyrene result, especially improved compared to the prior art. Especially, both the bending strength and resistance to pressure are improved.

Also, the demolding time is decreased, especially shorter pressure release times are achieved with the coating agent according to the present invention.

Moreover, the pre-expanded polystyrene beads coated with the coating agent according to the present invention, especially with at least one partial fatty acid ester of a polyglycerol, preferably comprising free hydroxyl-groups (OH-groups), do not lump or at least essentially do not lump; i.e. the lumping amount is usually 0 wt.-%. Thus, the pre-expanded polystyrene beads coated with the coating agent according to the present invention, especially with at least one partial fatty acid ester of a polyglycerol, preferably comprising free hydroxyl-groups (OH-groups), are ideal for further processing, especially molding. As a result, particularly high-quality and uniform products are obtained.

Surprisingly, when using the coating agent according to the present invention, especially at least one partial fatty acid ester of a polyglycerol, preferably comprising free hydroxyl-groups (OH-groups), no release agent is necessary. Especially, the molded polystyrene product can be easily and readily removed from the molding equipment.

Furthermore, when using expandable polystyrene beads coated according to the present invention, processability is well-balanced over the whole production process from pre-foaming to final molding.

To sum up, as stated hereinbefore, the present invention thus refers to a method for providing polystyrene beads, especially expandable polystyrene beads, with a coating, especially with an antistatic and/or antilumping coating,
wherein the method comprises the step of subjecting a plurality of polystyrene beads, especially expandable polystyrene beads, to a coating process in the presence of a coating agent, wherein during the coating process the coating agent is deposited on the surface of the polystyrene beads, especially such that the surface of the polystyrene beads is coated and/or covered at least essentially completely and/or homogeneously with the coating agent,
wherein the coating agent comprises or at least essentially consists of at least one fatty acid ester of a polyglycerol, especially at least one partial fatty acid ester of a polyglycerol, preferably comprising free hydroxyl-groups (OH-groups).

According to a preferred embodiment, the fatty acid of the fatty acid ester of a polyglycerol may be a C₁₄-C₂₂-fatty acid, especially a saturated C₁₄-C₂₂-fatty acid. In other words, the fatty acid radical of the fatty acid ester of a polyglycerol may be a C₁₄-C₂₂-fatty acid radical, especially a saturated C₁₄-C₂₂-fatty acid radical.

In this respect, a fatty acid radical refers to the ester-moiety derived from the fatty acid when esterified with the polyglycerol. Thus, a C₁₄-C₂₂-fatty acid radical refers to the general formula —C(O)—(C₁₃-C₂₁) etc.

According to another preferred embodiment, the fatty acid of the fatty acid ester of a polyglycerol may be a saturated fatty acid. In other words, the fatty acid radical of the fatty acid ester of a polyglycerol may be a saturated fatty acid radical.

When a saturated fatty acid, especially only saturated fatty acids, is comprised in the 10 fatty acid ester of a polyglycerol, an oxidation-stable ester is provided. Furthermore, the fatty acid ester of a polyglycerol is usually in solid form, making various coating processes possible (i.e. especially dry coating, wet coating and molten coating).

Additionally, according to a preferred embodiment, the fatty acid of the fatty acid ester of a polyglycerol may be a saturated, linear or branched, optionally substituted, especially optionally hydroxyl-substituted, fatty acid. In other words, the fatty acid radical of the fatty acid ester of a polyglycerol may be a saturated, linear or branched, optionally substituted, especially optionally hydroxyl-substituted, fatty acid radical. 20 According to a further preferred embodiment, the fatty acid of the fatty acid ester of a polyglycerol may be selected from the group consisting of hydroxystearic acid, isostearic acid, stearic acid, behenic acid and palmitic acid as well as mixtures and combinations thereof. In other words, the fatty acid radical of the fatty acid ester of a polyglycerol may be selected from the group consisting of hydroxystearic acid radical, isostearic acid radical, stearic acid radical, behenic acid radical and palmitic acid radical as well as mixtures and combinations thereof.

Especially, the fatty acid ester of a polyglycerol may be a partial ester, preferably a partial polyglycerol ester of a saturated fatty acid which ester comprises free hydroxyl-groups.

As already delineated hereinabove, when using a partial fatty acid ester of a polyglycerol, a multitude of ester-groups and also free hydroxyl-groups are provided simultaneously within one molecule leading to a well-balanced hydrophilicity/lipophilicity ratio and thus to excellent adhesion of the coating agent to the polystyrene beads. Especially, the free functional groups, particularly the carbon-chains, can interact especially well with the surface of the polystyrene beads, especially with the non-polar groups of the polystyrene beads, while leaving free OH-groups providing antistatic properties. This enables strong adhesion between the coating and the polystyrene beads and a homogeneous coating.

Thus, the fatty acid ester of a polyglycerol may especially be no full ester. In this respect, a full ester would refer to a fatty acid ester of a polyglycerol with no free hydroxyl-groups (OH-groups) or a fatty acid ester of a polyglycerol in which all hydroxyl-groups (OH-groups) are esterified with a fatty acid.

Particularly, the fatty acid ester of a polyglycerol may comprise free hydroxyl-groups (OH-groups).

As delineated hereinbefore, the fatty acid ester of a polyglycerol may especially be a 20 partial ester.

In this respect, it is preferred if the fatty acid ester of a polyglycerol has:
(i) a hydroxyl-value (HV) in the range of from 100 to 500 mg KOH/g, especially determined according to method of DGF C-V 17a (21) (Einheitsmethode der Deutschen Gesellschaft für Fettwissenschaft [Standard method of German Society for Fat Science]), and/or
(ii) an acid value (AV) of at most 1 mg KOH/g, especially determined according to method of DGF C-V 2 (20) (Einheitsmethode der Deutschen Gesellschaft für Fettwissenschaft [Standard method of German Society for Fat Science]), and/or
(iii) a saponification value (SV) in the range of from 75 to 200 mg KOH/g, especially determined according to method of DGF C-V 3 (02) (Einheitsmethode der Deutschen Gesellschaft für Fettwissenschaft [Standard method of German Society for Fat Science]).

Especially, the fatty acid ester may fulfill at least one, especially at least two, preferably all of the parameters (i), (ii) and (iii).

According to the present invention, the fatty acid ester of a polyglycerol, especially the partial fatty acid ester of a polyglycerol, may correspond to the following general formula (I)

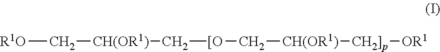

wherein, in the general formula (I),
   the variable p represents an integer from 1 to 5, preferably 2 or 3, more preferably 2, and
   the radical R¹, independently of one another, represents: hydrogen or a fatty acid radical, especially a C₁₄-C₂₂-fatty acid radical, preferably a saturated fatty acid radical, more preferably a saturated, linear or branched, optionally substituted, especially optionally hydroxyl-substituted, C₁₄-C₂₂-fatty acid radical, even more preferably is selected from the group consisting of a hydroxystearic acid radical, isostearic acid radical, stearic acid radical, behenic acid radical and palmitic acid radical as well as mixtures and combinations thereof.

Furthermore, according to a particular embodiment of the present invention, the fatty acid ester of a polyglycerol, especially the partial fatty acid ester of a polyglycerol, may correspond to the following general formula (I)

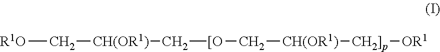

wherein, in the general formula (I),
   the variable p represents an integer from 1 to 5, preferably 2 or 3, more preferably 2, and
   the radical R¹, independently of one another, represents: hydrogen or a fatty acid radical, especially a C₁₄-C₂₂-fatty acid radical, preferably a saturated fatty acid radical, more preferably a saturated, linear or branched, optionally substituted, especially optionally hydroxyl-substituted, C₁₄-C₂₂-fatty acid radical, even more preferably is selected from the group consisting of a hydroxystearic acid radical, isostearic acid radical, stearic acid radical, behenic acid radical and palmitic acid radical as well as mixtures and combinations thereof;
however, with the proviso that at least one radical R¹, especially at least two radicals R¹, represents hydrogen and with the proviso that at least one radical R¹, especially at least two radicals R¹, represents a fatty acid radical and/or with the proviso that the fatty acid ester of a polyglycerol is a partial ester.

Moreover, according to a further particular embodiment of the present invention, the fatty acid ester of a polyglycerol, especially the partial fatty acid ester of a polyglycerol, may correspond to the following general formula (I)

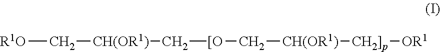

wherein, in the general formula (I),
   the variable p represents an integer from 1 to 5, preferably 2 or 3, more preferably 2, and
   the radical R¹, independently of one another, represents: hydrogen or a fatty acid radical, especially a C₁₄-C₂₂-fatty acid radical, preferably a saturated fatty acid radical, more preferably a saturated, linear or branched, optionally substituted, especially optionally hydroxyl-substituted, C₁₄-C₂₂-fatty acid radical, even more preferably is selected from the group consisting of a hydroxystearic acid radical, isostearic acid radical, stearic acid radical, behenic acid radical and palmitic acid radical as well as mixtures and combinations thereof;
however, with the proviso that the fatty acid ester of a polyglycerol has
(i) a hydroxyl-value (HV) in the range of from 100 to 500 mg KOH/g, especially determined according to method of DGF C-V 17a (21) (Einheitsmethode der Deutschen Gesellschaft für Fettwissenschaft [Standard method of German Society for Fat Science]), and/or
(ii) an acid value (AV) of at most 1 mg KOH/g, especially determined according to method of DGF C-V 2 (20) (Einheitsmethode der Deutschen Gesellschaft für Fettwissenschaft [Standard method of German Society for Fat Science]), and/or
(iii) a saponification value (SV) in the range of from 75 to 200 mg KOH/g, especially determined according to method of DGF C-V 3 (02) (Einheitsmethode der Deutschen Gesellschaft für Fettwissenschaft [Standard method of German Society for Fat Science]); especially wherein the fatty acid ester fulfills at least one, especially at least two, preferably all of the parameters (i), (ii) and (iii).

Additionally, according to another particular embodiment of the present invention, the fatty acid ester of a polyglycerol, especially the partial fatty acid ester of a polyglycerol, may correspond to the following general formula (I)

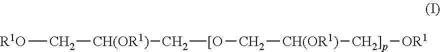

wherein, in the general formula (I),
   the variable p represents an integer from 1 to 5, preferably 2 or 3, more preferably 2, and
   the radical R¹, independently of one another, represents: hydrogen or a fatty acid radical, especially a C₁₄-C₂₂-fatty acid radical, preferably a saturated fatty acid radical, more preferably a saturated, linear or branched, optionally substituted, especially optionally hydroxyl-substituted, C₁₄-C₂₂-fatty acid radical, even more preferably is selected from the group consisting of a hydroxystearic acid radical, isostearic acid radical, stearic acid radical, behenic acid radical and palmitic acid radical as well as mixtures and combinations thereof;
however, with the proviso that at least one radical R¹, especially at least two radicals R¹, represents hydrogen and with the proviso that at least one radical R¹, especially at least two radicals R¹, represents a fatty acid radical and/or with the proviso that the fatty acid ester of a polyglycerol has
(i) a hydroxyl-value (HV) in the range of from 100 to 500 mg KOH/g, especially determined according to method of DGF C-V 17a (21) (Einheitsmethode der Deutschen Gesellschaft für Fettwissenschaft [Standard method of German Society for Fat Science]), and/or
(ii) an acid value (AV) of at most 1 mg KOH/g, especially determined according to method of DGF C-V 2 (20) (Einheitsmethode der Deutschen Gesellschaft für Fettwissenschaft [Standard method of German Society for Fat Science]), and/or
(iii) a saponification value (SV) in the range of from 75 to 200 mg KOH/g, especially determined according to method of DGF C-V 3 (02) (Einheitsmethode der Deutschen Gesellschaft für Fettwissenschaft [Standard method of German Society for Fat Science]);
especially wherein the fatty acid ester fulfills at least one, especially at least two, preferably all of the parameters (i), (ii) and (iii).

Furthermore, according to a further particular embodiment of the present invention, the fatty acid ester of a polyglycerol may be a partial fatty acid ester of a polyglycerol corresponding to the following general formula (I)

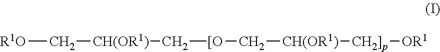

wherein, in the general formula (I),
   the variable p represents an integer from 1 to 5, preferably 2 or 3, more preferably 2, and
   the radical R¹, independently of one another, represents: hydrogen or a saturated fatty acid radical, especially a saturated C₁₄-C₂₂-fatty acid radical, preferably a saturated, linear or branched, optionally substituted, especially optionally hydroxyl-substituted, C₁₄-C₂₂-fatty acid radical, more preferably is selected from the group consisting of a hydroxystearic acid radical, isostearic acid radical, stearic acid radical, behenic acid radical and palmitic acid radical as well as mixtures and combinations thereof;
however, with the proviso that at least one radical R¹, especially at least two radicals R¹, represents hydrogen and with the proviso that at least one radical R¹, especially at least two radicals R¹, represents a saturated fatty acid radical and/or with the proviso that the partial fatty acid ester of a polyglycerol has
(i) a hydroxyl-value (HV) in the range of from 100 to 500 mg KOH/g, especially determined according to method of DGF C-V 17a (21) (Einheitsmethode der Deutschen Gesellschaft für Fettwissenschaft [Standard method of German Society for Fat Science]), and/or
(ii) an acid value (AV) of at most 1 mg KOH/g, especially determined according to method of DGF C-V 2 (20) (Einheitsmethode der Deutschen Gesellschaft für Fettwissenschaft [Standard method of German Society for Fat Science]), and/or
(iii) a saponification value (SV) in the range of from 75 to 200 mg KOH/g, especially determined according to method of DGF C-V 3 (02) (Einheitsmethode der Deutschen Gesellschaft für Fettwissenschaft [Standard method of German Society for Fat Science]); especially wherein the fatty acid ester fulfills at least one, especially at least two, preferably all of the parameters (i), (ii) and (iii).

Especially, according to the present invention, the fatty acid ester of a polyglycerol may be in a solid state at 20° C. and 1 bar. In other words, the fatty acid ester of a polyglycerol is solid at room temperature. Particularly, the fatty acid ester of a polyglycerol may be solid at 20° C. and 1 bar.

By using a fatty acid ester of a polyglycerol which is solid or in a solid state at 20° C. and 1 bar (i.e. room temperature), the coating agent is particularly adaptable and can be applied with different kinds of coating processes, especially in a dry coating process, especially powder coating process, and a wet coating process and a molten coating process. Especially the coating agent can be applied in dry form, especially powder form, or in liquid form (e. g. solved or suspended) or in molten form.

According to a preferred embodiment, the coating agent may be provided as a one-component (1K) coating agent. This means, that the coating agent essentially only consists of the at least one fatty acid of a polyglycerol; in other words, no additives are used in the coating agent. This leads to an improved processability and decreases errors in production and use or application of the coating agent. Furthermore, also the production of the coating agent is easier and less error-prone.

According to a further preferred embodiment, the coating agent may be free from and/or may not comprise any solvent, especially may be free from and/or does not comprise any hydrocarbons and/or alcohols.

According to an additional preferred embodiment, the coating agent may be free from and/or may not comprise any additives.

According to an even further preferred embodiment, the coating agent may be free from and/or may not comprise any metal compounds, especially metal soaps, especially metal stearates, preferably may be free from and/or may not comprise any zinc stearate, calcium stearate and magnesium stearate. Especially the absence of metal soaps, particularly metal stearates, is ecologically beneficial and furthermore allows for a wider use of the resulting product due to restrictions with respect to some substances (such as metal soaps) in specific areas (such as food-related areas etc.).

Furthermore, according to another preferred embodiment, the coating agent may be free from and/or may not comprise any amides, especially may be free from and/or may not comprise any fatty acid amides.

Moreover, it can also be preferred, if the coating agent is free from and/or does not comprise any waxes.

Additionally, another preferred embodiment may be, when the coating agent is free from and/or does not comprise any monoglycerides.

Especially, it may be preferred if the coating agent at least essentially consists of the at least one fatty acid ester of a polyglycerol, preferably consists of the at least one fatty acid ester of a polyglycerol.

Typically, the at least one fatty acid ester of a polyglycerol may be comprised by the coating agent in amounts in the range of from 50 to 100 wt.-%, especially in the range of from 70 to 100 wt.-%, preferably in the range of from 90 to 100 wt.-%, more preferably in the range of from 95 to 100 wt.-%, even more preferably in the range of from 98 to 100 wt.-%, most preferably 100 wt.-%, based on the coating agent. Especially, the remainder may be at least one additive, especially selected from the group consisting of metal compounds, especially metal soaps, especially metal stearates, preferably zinc stearate, calcium stearate and magnesium stearate, amides, especially fatty acid amides, waxes and monoglycerides as well as combinations and mixtures thereof.

According to an alternative embodiment, the coating agent may comprise at least one additive, especially selected from the group consisting of metal compounds, especially metal soaps, especially metal stearates, preferably zinc stearate, calcium stearate and magnesium stearate, amides, especially fatty acid amides, waxes and monoglycerides as well as combinations and mixtures thereof.

According to the present invention, it may especially be provided, that the coating agent, especially the at least one fatty acid ester of a polyglycerol, is applied in amounts in the range of from 0.1 to 0.8 parts per weight per 100 parts per weight of polystyrene beads, especially expressed as dry weight of the coating agent.

According to the present invention, the coating process may be performed in different forms. Especially, the coating process may be performed as a dry coating process, especially powder coating process, or a wet coating process or a molten coating process.

As already delineated hereinbefore, according to the present invention, the coating process may be performed as a dry coating process, particularly a powder coating process.

Typically, when the coating process is performed as a dry coating process, particularly a powder coating process, the coating agent may be used in a dry form, especially in powder form, and may be brought into contact with the polystyrene beads such that the coating agent is deposited on the surface of the polystyrene beads and/or such that the surface of the polystyrene beads is coated with the coating agent.

For dry coating of expandable polystyrene beads, typically the required amount of uncoated expandable polystyrene beads is filled into a mixer (e. g. a ribbon blender) and a fine powder of the coating agent is added to the expandable polystyrene beads. After sufficient mixing time, the coated expandable polystyrene beads can be used for further processing. Dry coating is the most common coating process in this industry.

As also delineated hereinbefore, according to the present invention it is also possible, that the coating process is performed as a wet coating process.

Usually, when the coating process is performed as a wet coating process, the coating agent may be used in the form of a solution or dispersion comprising the coating agent dissolved or dispersed in a liquid phase, wherein the solution or dispersion comprising the coating agent may be brought into contact with the polystyrene beads, followed by a drying step and/or by a removal of the liquid phase, such that the coating agent is deposited on the surface of the polystyrene beads and/or such that the surface of the polystyrene beads is coated with the coating agent.

Particularly, when the coating process is performed as a wet coating process, contacting may be performed by a dipping or spraying process. Accordingly, polystyrene beads are either dipped into the solution or dispersion of the coating agent or the solution or dispersion of the coating agent is sprayed onto the polystyrene beads.

As also delineated hereinbefore, according to the present invention it is also possible, that the coating process is performed as a molten coating process.

Especially, when the coating process is performed as a molten coating process, the coating agent may be used in a molten and/or liquid state, wherein the molten and/liquid coating agent may be brought into contact with the polystyrene beads, followed by a cooling step, such that the coating agent is deposited on the surface of the polystyrene beads and/or such that the surface of the polystyrene beads is coated with the coating agent.

Particularly, when the coating process is performed as a molten coating process, contacting is performed by a dipping or spraying process. Accordingly, polystyrene beads are dipped into the molten coating agent or the molten coating agent is sprayed onto the polystyrene beads.

According to the present invention, the polystyrene beads may be polymer particles, especially blowing agent-containing polymer particles, and/or wherein the polystyrene beads may comprise at least one blowing agent.

Within the scope of the present invention, a blowing agent refers to a material which boils below the softening point of the polymer and which will cause the polystyrene beads to expand when heated. To infuse the blowing agent into the polystyrene beads different techniques are known, for example pressure impregnation of thermoplastic polymer particles with blowing agents in a vessel, by suspension polymerization in the presence of blowing agents, or by melt impregnation in an extruder or static mixer followed by pressure (underwater) pelletizing.

Especially, the polystyrene beads may comprise the at least one blowing agent, especially at least one chemical or physical blowing agent, in amounts in the range of from 2 to 10 wt.-%, preferably in the range of from 3 to 7 wt.-%, based on the polystyrene beads.

Particularly, the at least one blowing agent may be a gas, especially selected from the group consisting of nitrogen, carbon dioxide, aliphatic hydrocarbons with 2 to 7 carbon atoms, alcohols, ketones, ethers and halogenated hydrocarbons as well as mixtures and combinations thereof, preferably selected from the group consisting of iso-butane, n-butane, iso-pentane, n-pentane, neo-pentane and hexane as well as combinations and mixtures thereof, more preferably from the group consisting of iso-pentane and n-pentane as well as combinations and mixtures thereof.

Furthermore, according to the present invention it might be intended, that the 10 polystyrene beads consist of at least one polystyrene-based polymer, especially selected from the group consisting of polystyrene homopolymers and polystyrene copolymers, such as alkylstyrenes, styrene-acrylonitrile (SAN) block copolymers, styrene-butadiene block copolymers, styrene-acrylic acid block copolymers and styrene-methacrylic acid block copolymers, as well as combinations and mixtures thereof.

Moreover, according to the present invention it might also be intended, that the polymeric material of the polystyrene beads consists of at least one polystyrene-based polymer, especially selected from the group consisting of polystyrene homopolymers and polystyrene copolymers, such as alkylstyrenes, styrene-acrylonitrile (SAN) block copolymers, styrene-butadiene block copolymers, styrene-acrylic acid block copolymers and styrene-methacrylic acid block copolymers, as well as combinations and mixtures thereof.

Thus, the polystyrene beads may consist of different polystyrene-comprising materials 25 and thus adapting and tailoring of the material properties is possible, especially by selecting the specific polystyrene-comprising material.

According to the present invention, it may be preferred if the polystyrene beads are expandable and/or foamable polystyrene particles, especially polystyrene particles expandable and/or foamable into expanded polystyrene particles, especially expandable and/or foamable by hot air or steam, especially wherein the polystyrene beads comprise at least one blowing agent.

According to the present invention, it may also be preferred if the polystyrene beads comprise at least one blowing agent, especially at least one chemical or physical blowing agent, particularly in amounts in the range of from 2 to 10 wt.-%, preferably in the range of from 3 to 7 wt.-%, based on the polystyrene beads.

According to the invention, it may furthermore be preferred if the at least one chemical or physical blowing agent is a gas, especially selected from the group consisting of nitrogen, carbon dioxide, aliphatic hydrocarbons with 2 to 7 carbon atoms, alcohols, ketones, ethers and halogenated hydrocarbons as well as mixtures and combinations thereof, preferably selected from the group consisting of iso-butane, n-butane, iso-pentane, n-pentane, neo-pentane and hexane as well as combinations and mixtures thereof, more preferably from the group consisting of iso-pentane and n-pentane as well as combinations and mixtures thereof.

Especially, according to the present invention, the expandable polystyrene particles may 20 be obtained and/or obtainable by pressure impregnation of polystyrene particles with the at least one blowing agent in a vessel or by suspension polymerization in the presence of the at least one blowing agent or by melt impregnation in an extruder or static mixer with subsequent pressure underwater pelletizing in the presence of the at least one blowing agent.

Particularly, according to the present invention, the polystyrene beads may contain customary additives, especially selected from the group consisting of dyes, pigments, fillers, IR-absorbers such as carbon black, aluminum or graphite, stabilizers, flame retardants such as hexabromocyclododecane (HBCD), brominated polymeric flame retardants, flame retardant synergists such as dicumyl or dicumyl peroxide, nucleating agents and slip agents as well as combinations and mixtures thereof.

By adding additives to the polystyrene polymer on which the beads are based, allows for further adaption and tailoring of the material properties.

With respect to the polystyrene beads used in the inventive method, the polystyrene beads may be in a spherical form or in a pear-shaped form or in a cylindrical form, especially wherein the form depends on the production process of the polystyrene beads.

In the following, in a purely exemplary manner, the production of expandable polystyrene beads according to the so-called Pickering method is described:

When using the inventive method, especially the inventive coating agent, all common shapes of polystyrene beads can be coated.

453 kg styrene are mixed together with the initiators (0.45 kg benzoyl peroxide and/or 1.35 kg dicumyl peroxide) in a 1 m³ stirred tank reactor filled with 520 kg water (It is also possible to run the polymerization with only one initiator. However, if low residual styrene levels of less than 1000 ppm are required, the use of a second initiator (finishing initiator), which does not intervene until later, is appropriate.). The filling level of the stirred tank reactor is 85% (i.e. 850 l). The reaction mixture is first added to a preparation vessel and the suspension is then transferred to the polymerization vessel. The reaction mixture is heated from 20° C. to 90° C. in 2 h, then from 90° C. to 130° C. in 4 h and is subsequently stirred for 5 h at 130° C. The stirrer is set to a speed of 120 rpm. After completion of the reaction, the bead-like product is washed, dried and sieved. Subsequently, the polystyrene beads are loaded with 35 kg n-pentane in a dosing time of 200 min.

Furthermore, the polystyrene beads used in the inventive method, may have a mean particle diameter (D50) in the range of from 0.05 to 5 mm, especially in the range of from 0.3 to 2.5 mm, especially determined according to ISO 13320:2020. In this respect, it is possible to divide the polystyrene beads before or after coating into individual fractions by sieving.

According to the present invention, it is preferred if the coating is provided as a homolayer.

Furthermore, according to the present invention, it is also preferred if the coating is provided as a homogeneous and/or continuous layer.

Additionally, according to the present invention, it is also preferred if the coating is provided defect-free and/or without any defects.

Moreover, according to the present invention, it is furthermore preferred if the coating is provided solvent-free. In other words, the coating resulting from the inventive method does not comprise any solvent. Thus, if the coating is applied in a wet coating process, the coating is dried completely (i.e. all solvent is removed).

According to the present invention, it might be intended that, after pre-expanding the coated polystyrene beads under typical conditions in water vapor, the lumping amount may be at most 0.25 wt.-%, preferably at most 0.2 wt.-%, more preferably at most 0.1 wt.-%, even more preferably 0 wt.-%. Thus, when using the inventive method and the coating agent according to the present invention, essentially no lumping occurs during or after pre-expansion.

Moreover, according to the present invention, it might also be intended that, after pre-expanding the coated polystyrene beads under typical conditions in water vapor, the pre-expanded polystyrene beads may have a mean particle diameter (D50) in the range of from 1 to 25 mm, especially 1 to 10 mm, preferably in the range of from 2 to 6 mm, especially determined according to ISO 13320:2020.

Furthermore, according to the present invention, it might also be intended that, after pre-expanding the coated polystyrene beads under typical conditions in water vapor, the expanded polystyrene beads may have a density in the range of from 5 to 200 kg/m³, especially in the range of from 5 to 150 kg/m³, preferably in the range of from 5 to 100 kg/m³.

According to the present invention, the molded product obtained and/or obtainable by pre-expanding and molding the coated polystyrene beads, may have a binding strength of at least 50 N, especially of at least 55 N, preferably of at least 58 N, especially determined according to DIN 53423.

Additionally, it might also be intended according to the present invention, that the molded product obtained and/or obtainable by pre-expanding and molding the coated polystyrene beads has a density in the range of from 5 to 32 kg/m³.

A further subject-matter—according to a second aspect of the present invention—are polystyrene beads, especially expandable polystyrene beads, provided with a coating, especially with an antistatic and/or antilumping coating, as obtainable by a method as delineated and defined hereinabove.

Especially, a subject-matter of the present invention—according to this aspect of the present invention—are polystyrene beads, especially expandable polystyrene beads, provided with a coating, especially with an antistatic and/or antilumping coating, especially as defined hereinabove,
wherein the coating comprises or at least essentially consists of at least one fatty acid ester of a polyglycerol, especially at least one partial fatty acid ester of a polyglycerol, preferably comprising free hydroxyl-groups (OH-groups).

As to further details relating to the second aspect of the invention, for avoidance of unnecessary repetition, reference may be made to the above explanations and remarks relating to the first aspect of the present invention (i.e. method of the present invention), which explanations and remarks accordingly apply mutatis mutandis also to this second aspect of the present invention.

Likewise, the present invention—according to a third aspect of the present invention—relates to a coating agent, especially for providing polystyrene beads, especially expandable polystyrene beads, with a coating, especially with an antistatic and/or antilumping coating, wherein the coating agent comprises or at least essentially consists of at least one fatty acid ester of a polyglycerol, especially at least one partial fatty acid ester of a polyglycerol, preferably comprising free hydroxyl-groups (OH-groups).

As to further details relating to the third aspect of the invention, for avoidance of unnecessary repetition, reference may be made to the above explanations and remarks relating to the first aspect of the present invention (i.e. method and polystyrene beads of the present invention), which explanations and remarks accordingly apply mutatis mutandis also to this second aspect of the present invention.

Furthermore, the present invention—according to a fourth aspect of the present invention—also relates to the use of at least one fatty acid ester of a polyglycerol, especially at least one fatty acid ester of a polyglycerol, especially at least one partial fatty acid ester of a polyglycerol, preferably comprising free hydroxyl-groups (OH-groups), as a coating agent for polystyrene beads, especially expandable polystyrene beads, particularly for providing polystyrene beads, especially expandable polystyrene beads, with a coating, especially with an antistatic and/or antilumping coating

Especially, a subject-matter of the present invention—according to this aspect of the present invention—is the use of at least one coating agent for polystyrene beads, especially expandable polystyrene beads, particularly for providing polystyrene beads, especially expandable polystyrene beads, with a coating, especially with an antistatic and/or antilumping coating, wherein the coating agent comprises or at least essentially consists of at least one fatty acid ester of a polyglycerol, especially at least one partial fatty acid ester of a polyglycerol, preferably comprising free hydroxyl-groups (OH-groups).

According to a particular embodiment of this aspect of the present invention, a plurality of polystyrene beads, especially expandable polystyrene beads, may be subjected to a coating process in the presence of a coating agent comprising or at least essentially consisting of the at least one fatty acid ester of a polyglycerol, wherein during the coating process the coating agent is deposited on the surface of the polystyrene beads, especially such that the surface of the polystyrene beads is coated and/or covered at least essentially completely and/or homogeneously with the coating agent.

Particularly, a subject-matter of the present invention—according to this aspect of the present invention—is the use of at least one coating agent for polystyrene beads, especially expandable polystyrene beads, particularly for providing polystyrene beads, especially expandable polystyrene beads, with a coating, especially with an antistatic and/or antilumping coating, wherein the coating agent comprises or at least essentially consists of at least one fatty acid ester of a polyglycerol, especially at least one partial fatty acid ester of a polyglycerol, preferably comprising free hydroxyl-groups (OH-groups), wherein a plurality of polystyrene beads, especially expandable polystyrene beads, is subjected to a coating process in the presence of a coating agent comprising or at least essentially consisting of the at least one fatty acid ester of a polyglycerol, wherein during the coating process the coating agent is deposited on the surface of the polystyrene beads, especially such that the surface of the polystyrene beads is coated and/or covered at least essentially completely and/or homogeneously with the coating agent.

As to further details relating to the fourth aspect of the invention, for avoidance of unnecessary repetition, reference may be made to the above explanations and remarks relating to the first aspect of the present invention (i.e. method, polystyrene beads and coating agent of the present invention), which explanations and remarks accordingly apply mutatis mutandis also to this second aspect of the present invention.

Further embodiments, modifications and variations of the present invention are readily recognizable or realizable by a person skilled in the art when reading the description, without leaving the scope of the present invention.

The present invention is illustrated by the following examples, which are not intended to limit the present invention in any way, but only to explain the exemplary and non-limiting implementation and configuration of the present invention.

### EXAMPLES

Comparison of Inventive Coating Agents with Comparative Coating Agents

In the following Examples 1 to 9, the respective coating agents as indicated hereinafter are each applied in a powder coating process (except Example 4, which is applied in a fluid process since tetraglycerol oleate is in a liquid state at 20° C. and 1 bar). If a multiple-component coating agent is used, the respective components are mixed in advance to result the overall coating agent in a powder form before coating. The uncoated expandable polystyrene beads used are commercially produced as provided by BASF SE Company, Germany, which have been produced either by suspension 5 polymerization of styrene (i.e. Examples 1 to 5) or by polymerization followed by extrusion (i.e. Examples 6 to 9); the used polystyrene beads have a particle size in the range of from 0.3 to 1.8 mm and comprise a blowing agent (i.e. pentane).

For the coating process, the following procedure is applied: Uncoated expandable 10 polystyrene beads and the coating agent are filled into a mixer (i.e. drum mixer purchased from J. Engelsmann AG, Germany, for dry or powder coating). The uncoated expandable polystyrene beads and the coating agent are contacted in the mixer and intensely mixed (5-times for 5 min each), so that a homogeneous coating is deposited on the surface of the expandable polystyrene beads, as confirmed by SEM-microscopy (scanning electron microscope).

Then the coated expandable polystyrene beads are pre-foamed in a pre-foaming device by providing 100 g coated expandable polystyrene beads in an agitated 51 glass apparatus with subsequent steaming the coated expandable polystyrene beads until the 20 beads have reached a density of around 20 g/l (full volume) in one shot. The elapsed time until the apparature is filled completely with pre-foamed expandable polystyrene beads is noted as the pre-foaming time. The pre-foamed expandable polystyrene beads are allowed to air dry overnight and are then screened to determine the lumping percentage and classified by sieving.

Finally, the pre-foamed expandable polystyrene beads are fused to blocks in a mold. Thereby, the pre-foamed expandable polystyrene beads are first filled in the mold and then the mold is tightly closed. Subsequently, air is removed by vacuum and then the mold and the contained pre-foamed expandable polystyrene beads are steamed with a pressure of up to 1.5 bar. Once the pressure is constant, pressure of the device is relieved to ambient pressure. The resulting blocks are recovered from the molds and dried to constant weight for further examination. The binding strength of the molded product is determined according to DIN 53423.

The results obtained are summarized in the following Tables 1 and 2.

TABLE 1
Examples 1 to 5

| | | | 3* | 4* | 5 |
|---|---|---|---|---|---|
| | 1* | 2* | full ester of | tetraglycerol | 56% glycerol tristearate |
| coating agent | partial ester of | partial ester of | diglycerol | oleate | 44% glycerol |
| composition | triglycerol stearate | triglycerol stearate | bahenate | (unsaturated ester) | monostearate |
| hydroxyl value | 236 | 236 | 4 | 40 | — |
| [mg KOH/g] | | | | | |
| saponification value | 140 | 140 | 140 | 168 | — |
| [mg KOH/g] | | | | | |
| acid value | 0.30 | 0.30 | 0.39 | 0.37 | — |
| [mg KOH/g] | | | | | |
| coating | 0.31 | 0.15 | 0.29 | 0.50 | 0.50 |
| concentration on | | | | | |
| EPS beads [%] | | | | | |
| lumping amount | 0 | 0 | 1.1 | 3.4 | 2.7 |
| [wt.-%] | | | | | |
| pre-foaming time | 0.4 | 0.45 | 0.5 | 1 | 0.5 |
| (relative to | | | | | |
| Example 4) | | | | | |
| binding strength | 59 | 57 | 45 | 32 | 55 |
| [N] | | | | | |

*inventive

TABLE 2
Examples 6 to 9

| | | 7* | 8* | 9 |
|---|---|---|---|---|
| | 6* | partial ester of | 85% triglycerol | 40% glycerol tristearate |
| coating agent | partial ester of | triglycerol | stearate | 40% glycerol monostearate |
| composition | triglycerol stearate | behenale | 15% silica | 20% zinc stearate |
| hydraxyl value | 235 | 134 | 236 | — |
| [mg KOH/g] | | | | |
| saponification | 140 | 129 | 140 | — |
| value | | | | |
| [mg KOH/g] | | | | |
| acid value | 0.30 | 0.24 | 0.30 | — |
| [mg KOH/g] | | | | |
| coating | 0.30 | 0.36 | 0.27 | 0.38 |
| concentration on | | | | |
| EPS beads [%] | | | | |
| lumping amount | 0.1 | 0 | 0.2 | 1.1 |
| [wt.-%] | | | | |
| pre-foaming time | 0.9 | 0.85 | 1 | 1 |
| (relative to | | | | |
| Example 4) | | | | |
| binding strength | 8.9 | 86 | 82 | 78 |
| [N] | | | | |

*inventive

The used partial esters of triglycerol in the above Examples each have (i) a hydroxyl-value (HV) in the range of from 100 to 500 mg KOH/g, determined according to method of DGF C-V 17a (21) (Einheitsmethode der Deutschen Gesellschaft für Fettwissenschaft [Standard method of German Society for Fat Science]), and (ii) an acid value (AV) of at most 1 mg KOH/g, determined according to method of DGF C-V 2 (20) (Einheitsmethode der Deutschen Gesellschaft für Fettwissenschaft [Standard method of German Society for Fat Science]), and (iii) a saponification value (SV) in the range of from 75 to 200 mg KOH/g, determined according to method of DGF C-V 3 (02) (Einheitsmethode der Deutschen Gesellschaft für Fettwissenschaft [Standard method of German Society for Fat Science]).

As shown by the above results, the inventive coatings comprising a partial fatty acid ester of a polyglycerol with the indicated parameters lead to improved results, as reflected by reduced lumping amounts, reduced pre-foaming times and increased binding strengths. Furthermore, the coating amount or amount of coating agent, respectively, can be reduced while still providing excellent coating results. Best results are obtained using a one-component system without further additives although principally the presence of further additives is not excluded.

### Comparison of Coating Processes Using Inventive Coating Agents

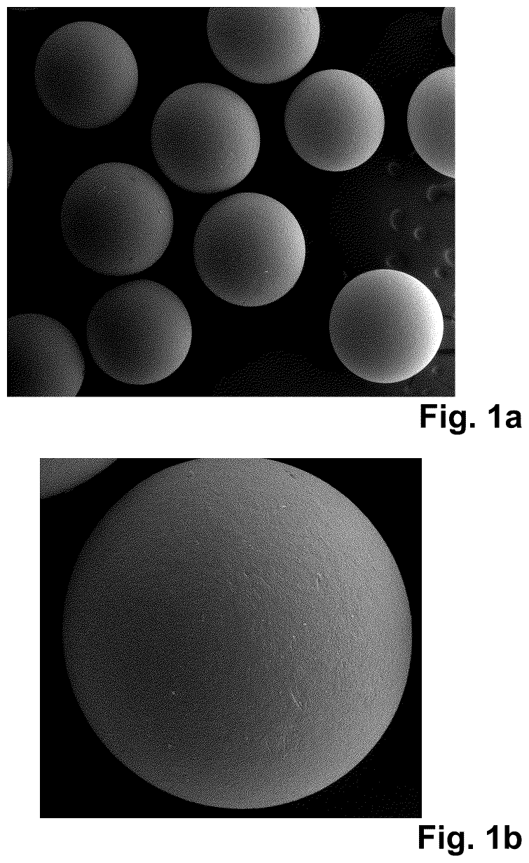

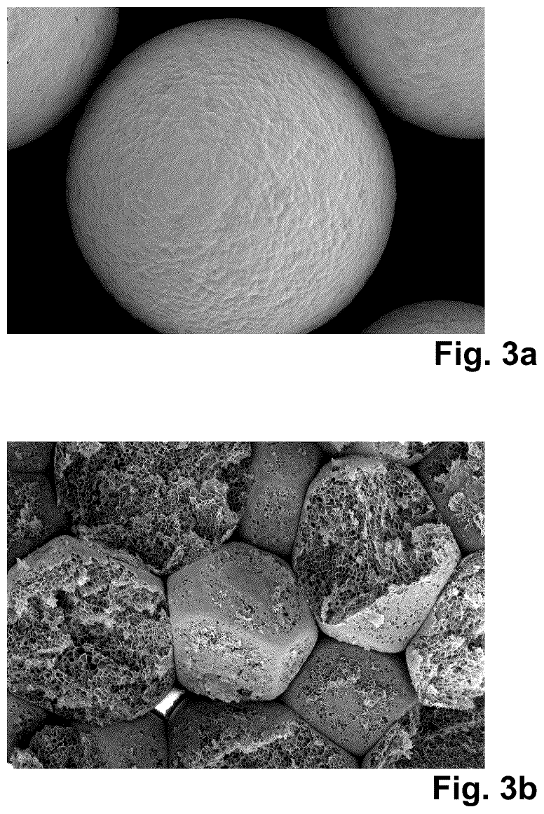

Subsequently, the expandable polystyrene beads of Example 1 are examined with a SEM-microscope to assess the coating quality. In FIG. 1a a 26-times magnified microscopic image of the expandable polystyrene beads coated in a dry coating process with a partial stearic ester of a triglycerol (i.e. above-described Example 1) is shown. In In FIG. 1b a 104-times magnified microscopic image of one of the particles, especially one of the expandable polystyrene beads coated in a dry coating process with a partial stearic ester of a triglycerol (i.e. above-described Example 1), is shown. Furthermore, in FIG. 3a a 28-times magnified microscopic image of one of the particles, especially one of the expandable polystyrene beads coated in a dry coating process with a partial stearic ester of a triglycerol (i.e. above-described Example 1), after pre-foaming is shown. As can be seen from these images a homogeneous and defect-free coating is deposited on the expandable polystyrene beads.

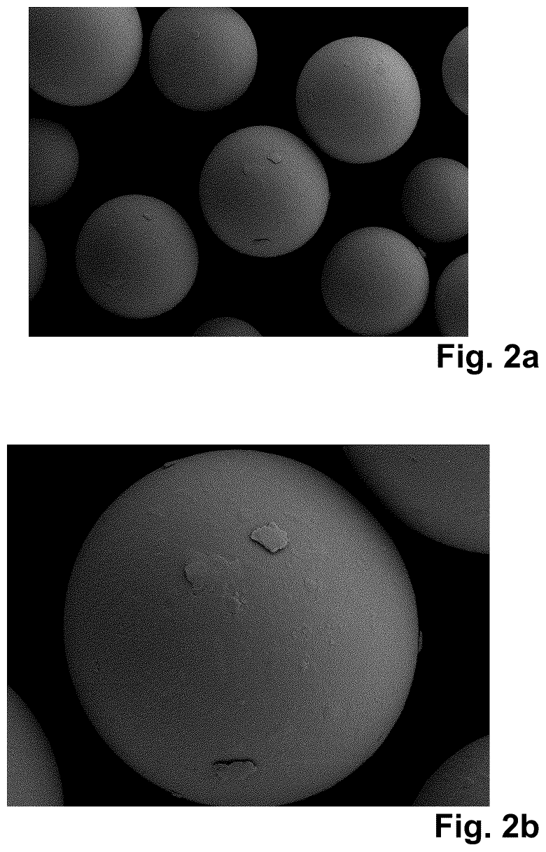

The coating agent described in Example 1 is also applied in a wet coating process and the resulting coated expandable polystyrene beads are also examined with a SEM-microscope to assess the coating quality. In FIG. 2a a 26-times magnified microscopic image of the expandable polystyrene beads coated in a wet coating process with a partial stearic ester of a triglycerol is shown. In In FIG. 2b a 104-times magnified microscopic image of one of the particles, especially one of the expandable polystyrene beads coated in a wet coating process with a partial stearic ester of a triglycerol, is shown. Also the application of the coating in a wet coating process results in an essentially homogeneous and defect-free coatings.

FIG. 3b shows a 15-times magnified microscopic image of a fracture edge of expanded polystyrene foam generated by expansion of expandable polystyrene beads coated in a dry coating process with a partial stearic ester of a triglycerol (i.e. above-described Example 1) resulting from a binding strength test. As can be seen from the image, the single expanded polystyrene beads within the foam block are fractured by the force of the binding strength test. This is due to the fact, that the fusion between the beads achieved by molding is particularly strong, which is also reflected by a high binding strength.

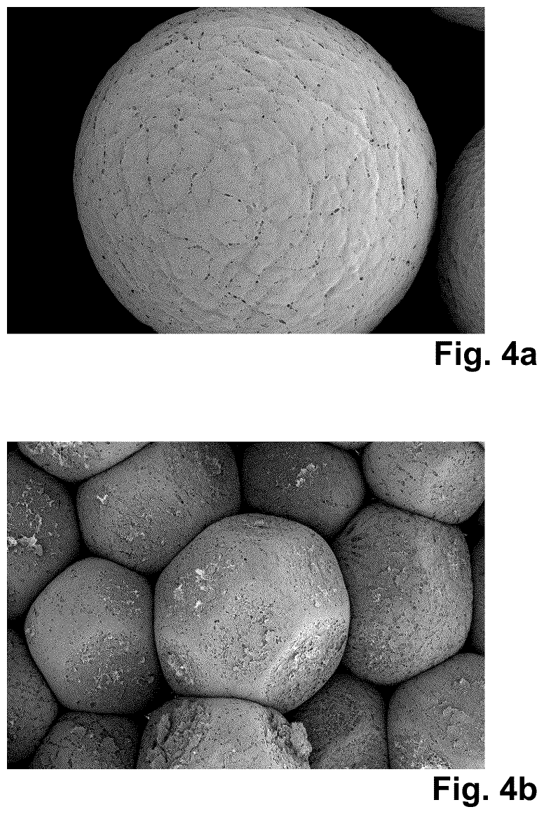

Also the expandable polystyrene beads of Example 4 are examined with a SEM-microscope to assess the coating quality. In FIG. 4a a 28-times magnified microscopic image of the expandable polystyrene beads coated in a wet coating process with a partial pentaoleate ester of a tetraglycerol (i.e. above-described Example 4) after pre-foaming is shown. As can be seen from this image, the surface of the pre-foamed beads coated with a partial pentaoleate ester of a tetraglycerol is widely damaged after pre-foaming.

Furthermore, as can be seen in FIG. 4b, which shows a 15-times magnified microscopic image of a fracture edge of expanded polystyrene foam generated by expansion of expandable polystyrene beads coated in a dry coating process with a partial pentaoleate ester of a tetraglycerol (i.e. above-described Example 4) resulting from a binding strength test, the single expanded polystyrene beads in the foam block are unbroken and the foam block rather broke along the fusion line of the expanded polystyrene beads. This is the result of a weaker fusion between the beads, which is also reflected by a lower binding strength.

Thus, the coating agent according to the present invention may be equally applied in a dry coating process or a wet coating process, resulting in each case in essentially homogeneous and defect-free coatings. Especially, with both processes no lumping occurs during or after pre-foaming.

1-136. (canceled)

1-15. (canceled)

137. A method for providing expandable polystyrene beads with a coating,
wherein the method comprises the step of subjecting a plurality of expandable polystyrene beads to a coating process in the presence of a coating agent, wherein during the coating process the coating agent is deposited on the surface of the expandable polystyrene beads such that the surface of the expandable polystyrene beads is coated at least essentially completely and homogeneously with the coating agent,
wherein the coating agent comprises at least one partial polyglycerol ester of a saturated fatty acid which ester comprises free hydroxyl-groups;
wherein the at least one partial polyglycerol ester of a saturated fatty acid which ester comprises free hydroxyl-groups fulfills at least one of the parameters (i), (ii) and (iii):
(i) a hydroxyl-value (HV) in the range of from 100 to 500 mg KOH/g, determined according to method of DGF C-V 17a (21) (Einheitsmethode der Deutschen Gesellschaft für Fettwissenschaft [Standard method of German Society for Fat Science]),
(ii) an acid value (AV) of at most 1 mg KOH/g, determined according to method of DGF C-V 2 (20) (Einheitsmethode der Deutschen Gesellschaft für Fettwissenschaft [Standard method of German Society for Fat Science]),
(iii) a saponification value (SV) in the range of from 75 to 200 mg KOH/g, determined according to method of DGF C-V 3 (02) (Einheitsmethode der Deutschen Gesellschaft für Fettwissenschaft [Standard method of German Society for Fat Science]); and
wherein the at least one partial polyglycerol ester of a saturated fatty acid which ester comprises free hydroxyl-groups corresponds to the following general formula (I) 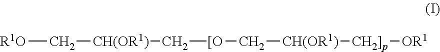
wherein, in the general formula (I),
the variable p represents an integer from 1 to 5, and
the radical R¹, independently of one another, represents a radical selected from the group consisting of hydrogen and a saturated fatty acid radical;
however, with the proviso that at least one radical R¹ represents hydrogen and with the proviso that at least one radical R¹ represents a fatty acid radical.

138. The method according to claim 137,
wherein the at least one partial polyglycerol ester of a saturated fatty acid which ester comprises free hydroxyl-groups fulfills all of the parameters (i), (ii) and (iii).

139. The method according to claim 137,
wherein the expandable polystyrene beads have a mean particle diameter D50 in the range of from 0.05 to 5 mm, determined according to ISO 13320:2020.

140. The method according to claim 137,
wherein the coating is at least one of an antistatic and antilumping coating.

141. The method according to claim 137,
wherein the coating agent is applied in amounts in the range of from 0.1 to 0.8 parts per weight per 100 parts per weight of the expandable polystyrene beads, expressed as dry weight of the coating agent.

142. The method according to claim 137,
wherein the coating agent at least essentially consists of the at least one partial polyglycerol ester of a saturated fatty acid which ester comprises free hydroxyl-groups.

143. The method according to claim 137,
wherein the coating agent does not comprise any metal compounds.

144. The method according to claim 137,
wherein the coating agent fulfills at least one of the characteristics (a) to (j):
(a) the at least one partial polyglycerol ester of a saturated fatty acid which ester comprises free hydroxyl-groups and which ester is comprised by the coating agent is in a solid state at 20° C. and 1 bar;
(b) the coating agent is a one-component coating agent;
(c) the coating agent is free from any solvent;
(d) the coating agent is free from any hydrocarbons and any alcohols;
(e) the coating agent is free from any additives;
(f) the coating agent is free from any metal compounds;
(g) the coating agent is free from any metal soaps and any metal stearates;
(h) the coating agent is free from any amides;
(i) the coating agent is free from any waxes;
(j) the coating agent is free from any monoglycerides.

145. The method according to claim 137,
wherein the at least one partial polyglycerol ester of a saturated fatty acid which ester comprises free hydroxyl-groups is comprised by the coating agent in amounts in the range of from 50 to 100 wt.-%, based on the coating agent; wherein the remainder is at least one additive.

146. The method according to claim 137,
wherein the coating process is performed as a process selected from the group consisting of dry coating processes, powder coating processes, wet coating processes, molten coating processes and combinations thereof.

147. Expandable polystyrene beads provided with a coating,
wherein the coating comprises at least one partial polyglycerol ester of a saturated fatty acid which ester comprises free hydroxyl-groups;
wherein the at least one partial polyglycerol ester of a saturated fatty acid which ester comprises free hydroxyl-groups fulfills at least one of the parameters (i), (ii) and (iii):
(i) a hydroxyl-value (HV) in the range of from 100 to 500 mg KOH/g, determined according to method of DGF C-V 17a (21) (Einheitsmethode der Deutschen Gesellschaft für Fettwissenschaft [Standard method of German Society for Fat Science]),
(ii) an acid value (AV) of at most 1 mg KOH/g, determined according to method of DGF C-V 2 (20) (Einheitsmethode der Deutschen Gesellschaft für Fettwissenschaft [Standard method of German Society for Fat Science]),
(iii) a saponification value (SV) in the range of from 75 to 200 mg KOH/g, determined according to method of DGF C-V 3 (02) (Einheitsmethode der Deutschen Gesellschaft für Fettwissenschaft [Standard method of German Society for Fat Science]); and
wherein the at least one partial polyglycerol ester of a saturated fatty acid which ester comprises free hydroxyl-groups corresponds to the following general formula (I) 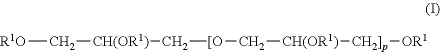
wherein, in the general formula (I),
the variable p represents an integer from 1 to 5, and
the radical R¹, independently of one another, represents a radical selected from the group consisting of hydrogen and a saturated fatty acid radical;
however, with the proviso that at least one radical R¹ represents hydrogen and with the proviso that at least one radical R¹ represents a fatty acid radical.

148. The expandable polystyrene beads according to claim 147,
wherein the at least one partial polyglycerol ester of a saturated fatty acid which ester comprises free hydroxyl-groups fulfills all of the parameters (i), (ii) and (iii).

149. The expandable polystyrene beads according to claim 147,
wherein the expandable polystyrene beads have a mean particle diameter D50 in the range of from 0.05 to 5 mm, determined according to ISO 13320:2020.

150. The expandable polystyrene beads according to claim 147,
wherein the coating is at least one of an antistatic and antilumping coating.

151. The expandable polystyrene beads according to claim 147,
wherein the expandable polystyrene beads comprise the coating in amounts in the range of from 0.1 to 0.8 parts per weight per 100 parts per weight of the expandable polystyrene beads, expressed as dry weight of the coating.

152. The expandable polystyrene beads according to claim 147,
wherein the coating does not comprise any metal compounds.

153. The expandable polystyrene beads according to claim 147,
wherein the at least one partial polyglycerol ester of a saturated fatty acid which ester comprises free hydroxyl-groups corresponds to the following general formula (I) 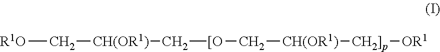
wherein, in the general formula (I),
the variable p represents an integer from 1 to 5, and
the radical R¹, independently of one another, represents a radical selected from the group consisting of hydrogen, a C₁₄-C₂₂-fatty acid radical and a hydroxyl-substituted C₁₄-C₂₂-fatty acid radical;
however, with the proviso that at least one radical R¹ represents hydrogen and with the proviso that at least one radical R¹ represents a C₁₄-C₂₂-fatty acid radical.

154. The expandable polystyrene beads according to claim 147,
wherein the coating agent fulfills at least one of the characteristics (a) to (j):
(a) the at least one partial polyglycerol ester of a saturated fatty acid which ester comprises free hydroxyl-groups and which ester is comprised by the coating is in a solid state at 20° C. and 1 bar;
(b) the coating is a one-component coating;
(c) the coating is free from any solvent;
(d) the coating is free from any hydrocarbons and any alcohols;
(e) the coating is free from any additives;
(f) the coating is free from any metal compounds;
(g) the coating is free from any metal soaps and any metal stearates;
(h) the coating is free from any amides;
(i) the coating is free from any waxes;
(j) the coating is free from any monoglycerides.

155. The expandable polystyrene beads according to claim 147,
wherein the at least one partial polyglycerol ester of a saturated fatty acid which ester comprises free hydroxyl-groups is comprised by the coating in amounts in the range of from 50 to 100 wt.-%, based on the coating; wherein the remainder is at least one additive.

156. The expandable polystyrene beads according to claim 147,
wherein the coating comprises at least one additive selected from the group consisting of amides, waxes and monoglycerides and combinations and mixtures thereof.

157. The expandable polystyrene beads according to claim 147,
wherein the expandable polystyrene beads comprise at least one blowing agent;
wherein the expandable polystyrene beads comprise the at least one blowing agent, in amounts in the range of from 2 to 10 wt.-%, based on the expandable polystyrene beads; and
wherein the at least one blowing agent is a gas selected from the group consisting of nitrogen, carbon dioxide, aliphatic hydrocarbons with 2 to 7 carbon atoms, alcohols, ketones, ethers and halogenated hydrocarbons and mixtures and combinations thereof.

158. The expandable polystyrene beads according to claim 147,
wherein the expandable polystyrene beads consist of at least one polystyrene-based polymer selected from the group consisting of polystyrene homopolymers and polystyrene copolymers, alkylstyrenes, styrene-acrylonitrile block copolymers, styrene-butadiene block copolymers, styrene-acrylic acid block copolymers and styrene-methacrylic acid block copolymers and combinations and mixtures thereof.

159. The expandable polystyrene beads according to claim 147,
wherein the expandable polystyrene beads contain customary additives selected from the group consisting of dyes, pigments, fillers, IR-absorbers, carbon black, aluminum, graphite, stabilizers, flame retardants, hexabromocyclododecane, brominated polymeric flame retardants, flame retardant synergists, dicumyl peroxide, nucleating agents and slip agents and combinations and mixtures thereof; and
wherein the expandable polystyrene beads are in form selecting from the group consisting of a spherical form, a pear-shaped form and a cylindrical form.

160. The expandable polystyrene beads according to claim 147,
wherein, after pre-expanding the coated expandable polystyrene beads under typical conditions in water vapor, the lumping amount is at most 0.25 wt.-%.

161. The expandable polystyrene beads according to claim 147,
wherein, after pre-expanding the coated expandable polystyrene beads under typical conditions in water vapor, the pre-expanded polystyrene beads have a mean particle diameter D50 in the range of from 1 to 25 mm, determined according to ISO 13320:2020.

162. The expandable polystyrene beads according to claim 147,
wherein, after pre-expanding the coated expandable polystyrene beads under typical conditions in water vapor, the expanded polystyrene beads have a density in the range of from 5 to 200 kg/m³.

163. The expandable polystyrene beads according to claim 147,
wherein a molded product obtained by pre-expanding and molding the coated expandable polystyrene beads, has a binding strength of at least 50 N, determined according to DIN 53423.

164. The expandable polystyrene beads according to claim 147,
wherein the molded product obtained by pre-expanding and molding the coated expandable polystyrene beads has a density in the range of from 5 to 32 kg/m³.

165. Expandable polystyrene beads provided with a coating,
wherein the expandable polystyrene beads are obtained by the method according to claim 137.

166. A method for providing expandable polystyrene beads with a coating having at least one of an antistatic and antilumping effect,
wherein the method comprising the step of using at least one partial polyglycerol ester of a saturated fatty acid which ester comprises free hydroxyl-groups as a coating agent for the expandable polystyrene beads, for providing expandable polystyrene beads with a coating having at least one of an antistatic and antilumping effect,
wherein the at least one partial polyglycerol ester of a saturated fatty acid which ester comprises free hydroxyl-groups fulfills at least one of the parameters (i), (ii) and (iii):
(i) a hydroxyl-value (HV) in the range of from 100 to 500 mg KOH/g, determined according to method of DGF C-V 17a (21) (Einheitsmethode der Deutschen Gesellschaft für Fettwissenschaft [Standard method of German Society for Fat Science]),
(ii) an acid value (AV) of at most 1 mg KOH/g, determined according to method of DGF C-V 2 (20) (Einheitsmethode der Deutschen Gesellschaft für Fettwissenschaft [Standard method of German Society for Fat Science]),
(iii) a saponification value (SV) in the range of from 75 to 200 mg KOH/g, determined according to method of DGF C-V 3 (02) (Einheitsmethode der Deutschen Gesellschaft für Fettwissenschaft [Standard method of German Society for Fat Science]);
wherein the at least one partial polyglycerol ester of a saturated fatty acid which ester comprises free hydroxyl-groups corresponds to the following general formula (I) 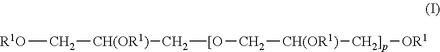
wherein, in the general formula (I),
the variable p represents an integer from 1 to 5, and
the radical R¹, independently of one another, represents a radical selected from the group consisting of hydrogen and a saturated fatty acid radical;
however, with the proviso that at least one radical R¹ represents hydrogen and with the proviso that at least one radical R¹ represents a fatty acid radical;
wherein the coating does not comprise any metal compounds, and
wherein the polystyrene beads have a mean particle diameter (D50) in the range of from 0.05 to 5 mm, determined according to ISO 13320:2020.
